(19) United States
(12) Patent Application Publication
(10) Pub. No.: US 2013/0017882 A1
(43) Pub. Date: Jan. 17, 2013

(54) SYSTEMS AND METHODS OF CONDUCTING A GAME OF CHANCE

(71) Applicants: Vladimir Dunaevsky, Toronto (CA); Justin L. Thouin, Toronto (CA)

(72) Inventors: Vladimir Dunaevsky, Toronto (CA); Justin L. Thouin, Toronto (CA)

(21) Appl. No.: 13/350,115

(22) Filed: Jan. 13, 2012

Related U.S. Application Data
(63) Continuation of application No. 12/389,601, filed on Feb. 20, 2009, now abandoned.
(60) Provisional application No. 61/032,534, filed on Feb. 29, 2008.

(51) Int. Cl. A63F 13/00

(52) U.S. Cl. 463/20

(57) ABSTRACT

Systems and methods of conducting a video game of chance are disclosed. The method includes: (a) receiving a first wager from a first player and a second wager from a second player; (b) populating a first group of cells with symbols, where the first group of cells is associated with the first player; (c) populating a second group of cells with symbols, where the second group of cells is associated with the second player; (d) determining whether the first group of symbols includes a winning combination; (e) if so, determining a first award for the winning combination; (f) determining whether the second group of symbols includes a winning combination; (g) if so, determining a second award for the winning combination; and (h) selecting a round winner based on a comparison of the first and second award.

### CROSS-REFERENCE TO RELATED APPLICATIONS

This application is a continuation of U.S. patent application Ser. No. 12/389,601, filed on Feb. 20, 2009, which claims priority to U.S. Provisional Application No. 61/032,534 filed on Feb. 29, 2008, all of which are herein incorporated by reference herein in their entirety.

### TECHNICAL FIELD

The present invention relates to a game of chance. In particular, the invention relates to a game of chance implemented as a video slot game.

### BACKGROUND

Playing video games is a very popular and well-known entertainment activity. There is a large variety of video games available to consumers. One category of video games is the games of chance category. Some examples of video games of chance include video poker and video slot games.

Slot machine games were originally designed for mechanical machines that used a number of physically rotating wheels actuated by a user inserting a coin or token and pulling down a lever.

The advent of video slot games permitted game designers to be more creative by eliminating the limitations associated with physical reels and mechanical machines. The designers were no longer limited to physical reels having a fixed number of symbols per reel. Video slot games permitted game designers to easily create any number of virtual reels with any number of symbols on each reel.

### BRIEF DESCRIPTION OF THE DRAWINGS

For a better understanding of embodiments of the systems and methods described herein, and to show more clearly how they may be carried into effect, reference will be made, by way of example, to the accompanying drawings in which:

FIG. 1 is a block diagram of a system for conducting a video game of chance according to an embodiment of the present invention;

FIG. 2 is a perspective view of a standalone gaming machine for conducting a video game of chance according to an embodiment of the present invention;

FIG. 3 is a screen shot of the video game according to an embodiment of the present invention; and

FIG. 4 is a flowchart of the steps of a method of conducting a video game of chance according to an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### SUMMARY

According to a first aspect of the invention, a method of conducting a video game of chance is provided. The method comprises:

a) receiving a first wager from a first player and a second wager from a second player;
b) populating a first plurality of cells with a first plurality of symbols, wherein the first plurality of cells is associated with the first player;
c) populating a second plurality of cells with a second plurality of symbols, wherein the second plurality of cells is associated with the second player;
d) determining whether the first plurality of symbols comprise at least one first winning combination;
e) if the first plurality of cells comprises the at least one first winning combination, determining a first award for the at least one first winning combination;
f) determining whether the second plurality of symbols comprises at least one second winning combination;
g) if the second plurality of cells comprises the at least one second winning combination, determining a second award for the at least one second winning combination; and
h) selecting a round winner based on a comparison of the first and second award, wherein the first player is selected as the round winner if the first award exceeds the second award, wherein the second player is selected as the round winner if the second award exceeds the first award.

According to a second aspect of the invention, a method of playing a video game of chance is provided. The method comprises:

a) communicating a first wager from a first player and a second wager from a second player;
b) displaying a first plurality of cells populated with a first plurality of symbols, wherein the second plurality of cells is associated with the second player;
c) displaying a second plurality of cells populated with a second plurality of symbols, wherein the first plurality of cells is associated with the first player;
d) if the first plurality of symbols comprises at least one first winning combination, displaying a first award to the first player, wherein the first award is determined from the at least one first winning combination;
e) if the second plurality of symbols comprises at least one second winning combination, displaying the second award to the second player, wherein the second award is determined from the at least one second combination; and
f) displaying a round winner based on a comparison of the first and second award, wherein the first player is selected as the round winner if the first award exceeds the second award, wherein the second player is selected as the round winner if the second award exceeds the first award.

According to a third aspect of the invention, a system for conducting a video game of chance between a first player and a second player is provided. The system comprises a server and a client device adapted for communication with the server. The client device includes a display. The client device is adapted to receive a first wager and communicate the first wager to the server. The display is adapted to display a first plurality of cells populated with a first plurality of symbols and a second plurality of cells populated with a second plurality of symbols. The first wager is associated with a first plurality of cells, and the second plurality of cells is associated with a second wager. The server is adapted to: (i) determine whether the first plurality of symbols comprise at least one first winning combination, and if the first plurality of symbols comprise at least one first winning combination, determine a first award for the at least one first winning combination; and (ii) determine whether the second plurality of symbols comprise at least one second winning combination, and if the second plurality of symbols comprise at least one second winning combination, determine a second award for the at least one second winning combination. The server is adapted to select a round winner based on a comparison of the first and second award. The first player is selected as the round winner if the first award exceeds the second award. The second player is selected as the round winner if the second award exceeds the first award.

According to a fourth aspect of the invention, a gaming machine for conducting a video game of chance between a first player and a second player is provided. The machine comprises: (a) a processor, (b) a memory, (c) an input interface; and (d) a display. The input interface is adapted to receive a first wager and store the first wager in the memory. The display is adapted to display a first plurality of cells populated with a first plurality of symbols and a second plurality of cells populated with a second plurality of symbols. The first wager is associated with a first plurality of cells, and the second plurality of cells is associated with a second wager. The processor is adapted to: (i) determine whether the first plurality of symbols comprise at least one first winning combination, and if the first plurality of symbols comprise at least one first winning combination, determine a first award for the at least one first winning combination; and (ii) determine whether the second plurality of symbols comprise at least one second winning combination, and if the second plurality of symbols comprise at least one second winning combination, determine a second award for the at least one second winning combination. The processor is adapted to select a round winner based on a comparison of the first and second award. The first player is selected as the round winner if the first award exceeds the second award. The second player is selected as the round winner if the second award exceeds the first award.

### DETAILED DESCRIPTION

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

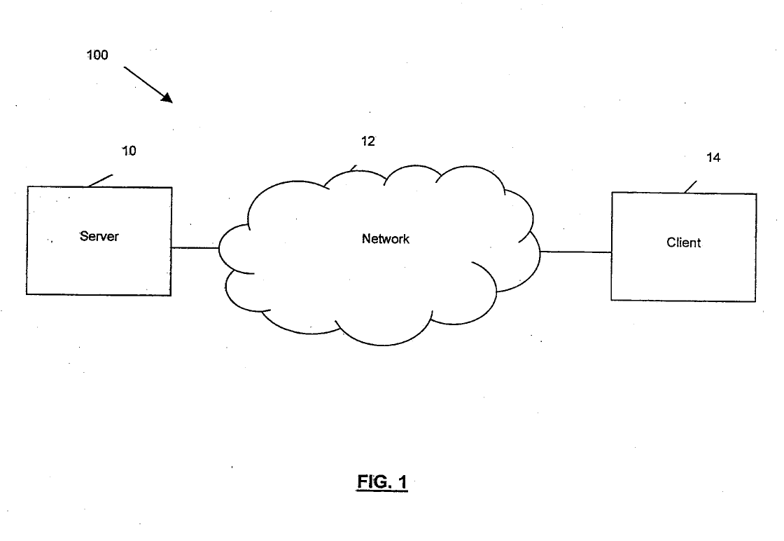

Reference is now made to FIG. 1, in which a system 100 for conducting a video game of chance is illustrated. The system 100 includes a client device 14 that is connected to a host server 10 via a network 12. A first player uses the client device 14 to access the game, which is hosted on the host server 10. The game is implemented electronically by software that is installed on the host server 10.

The host server 10 is preferably implemented by the use of one or more general purpose computers, such as, for example, a Sun Microsystems™ F15K server. The client device 14 is also preferably implemented by the use of one or more general purpose computers, such as, for example, a typical personal computer manufactured by Dell™, Gateway™, or Hewlett-Packard™. Those skilled in the art will understand that the client device 14 may be any other suitable device, such as a game console, a portable gaming device, a laptop computer, a personal digital assistant (PDA), a mobile phone, a set top box, or an interactive television.

Each of the host server 10 and the client device 14 may include a microprocessor. The microprocessor can be any type of processor, such as, for example, any type of general purpose microprocessor or microcontroller, a digital signal processing (DSP) processor, an application-specific integrated circuit (ASIC), a programmable read-only memory (PROM), or any combination thereof. The host server 10 may use its microprocessor to read a computer-readable medium containing the software that includes instructions for carrying out one or more of the functions of the host server 10, as further described below.

Each of the host server 10 and the client device 14 can also include computer memory, such as, for example, random-access memory (RAM). However, the computer memory of each of the host server 10 and the client device 14 can be any type of computer memory or any other type of electronic storage medium that is located either internally or externally to the host server 10 or the client device 14, such as, for example, read-only memory (ROM), compact disc read-only memory (CDROM), electro-optical memory, magneto-optical memory, erasable programmable read-only memory (EPROM), and electrically-erasable programmable read-only memory (EEPROM), or the like.

According to exemplary embodiments, the respective RAM can contain, for example, the operating program for either the host server 10 or the client device 14. As will be appreciated based on the following description, the RAM, can, for example, be programmed using conventional techniques known to those having ordinary skill in the art of computer programming. The actual source code or object code for carrying out the steps of, for example, a computer program can be stored in the RAM.

Each of the host server 10 and the client device 14 can also include a database. The database can be any type of computer database for storing, maintaining, and allowing access to electronic information stored therein.

The host server 10 preferably resides on a network 12, such as a local area network (LAN), a wide area network (WAN), or the Internet. The client device 14 preferably is connected to the network 12 on which the host server 10 resides, thus enabling electronic communications between the host server 10 and the client device 14 over a communications connection, whether locally or remotely, such as, for example, an Ethernet connection, an RS-232 connection, or the like.

The client device typically includes a monitor or other display for displaying the actions and status of the video game. The client device 14 may be configured to accept player inputs provided via, for example, a keyboard, mouse, a joystick or a touchscreen.

The video game may be played in one of two modes: peer-to-computer mode or peer-to-peer mode. In peer-to-computer mode, a live player plays the game against a computer (also referred to as the House). In peer-to-peer mode, one live player plays the game against another live player. Where the game is being played in peer-to-peer mode, system 100 shown in FIG. 1 will further comprise a second client device 14 (only one is shown in FIG. 1) connected to the network 12 and in communication with the host server 10.

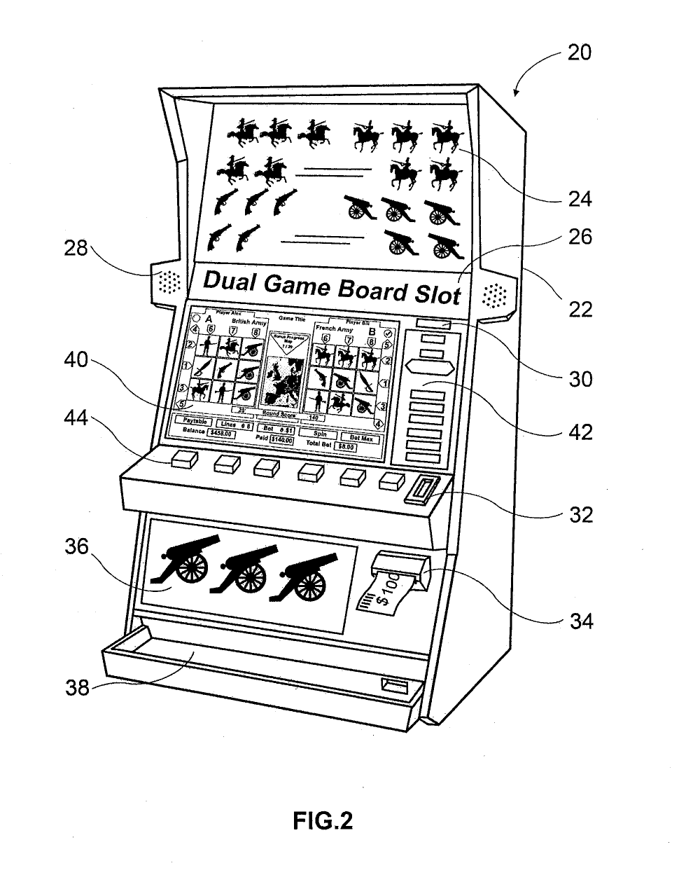

Reference is now made to FIG. 2, in which a standalone gaming machine for conducting the game of chance is illustrated. The standalone gaming machine may be a video slot machine 20. The slot machine 20 is housed in a cabinet 22. The slot machine includes a reference plate 24 that identifies the type of game played on the slot machine 20, a name plate 26, speakers 28, a bill acceptor 30, a coin slot 32, a ticket slot 34 for coinless play, belly art plate 36, and a coin try 38. The slot machine also includes a video display 40, a game playing instructions plate 42, and an input interface, such as game function buttons 44 for one or more players. In the peer-to-peer mode, the game may be played by two players on a single gaming machine 20, or the game may be implemented using two or more gaming machines 20 which communicate with each other using any suitable network.

Those skilled in the art will understand that the video game of chance may be implemented on a wide variety of other standalone gaming devices, such as game consoles, portable gaming devices, personal computers, laptop computers, personal digital assistants (PDAs), mobile phones, set top boxes, and interactive televisions.

Preferably the gaming machine 20, includes a microprocessor (not shown). The microprocessor can be any type of processor, such as, for example, any type of general purpose microprocessor or microcontroller, a digital signal processing (DSP) processor, an application-specific integrated circuit (ASIC), a programmable read-only memory (PROM), or any combination thereof. The video slot machine 20 may use its microprocessor to read a computer-readable medium containing the software that includes instructions for carrying out one or more of the functions of the game described below.

Preferably, the video slot machine 20 also includes computer memory, such as, for example, random-access memory (RAM). However, the computer memory of video slot machine 20 may be any other type of computer memory or any other type of electronic storage medium, such as, for example, read-only memory (ROM), compact disc read-only memory (CDROM), electro-optical memory, magneto-optical memory, erasable programmable read-only memory (EPROM), and electrically-erasable programmable read-only memory (EEPROM), or the like.

According to exemplary embodiments, the memory of the video slot machine 20 may contain, for example, the operating instructions to implement the functionality of the game described below. As will be appreciated based on the following description, the memory, can, for example, be programmed using conventional techniques known to those having ordinary skill in the art of computer programming. The actual source code or object code for carrying out the steps of, for example, a computer program can be stored in the memory.

The video slot machine 20 can also include a data storage, such as a database. The database may be any suitable type of computer database for storing, maintaining, and allowing access to electronic information stored therein.

The display 40 of the video slot machine 20 or the display of the client device (depending on the embodiment) is configured to display the game board.

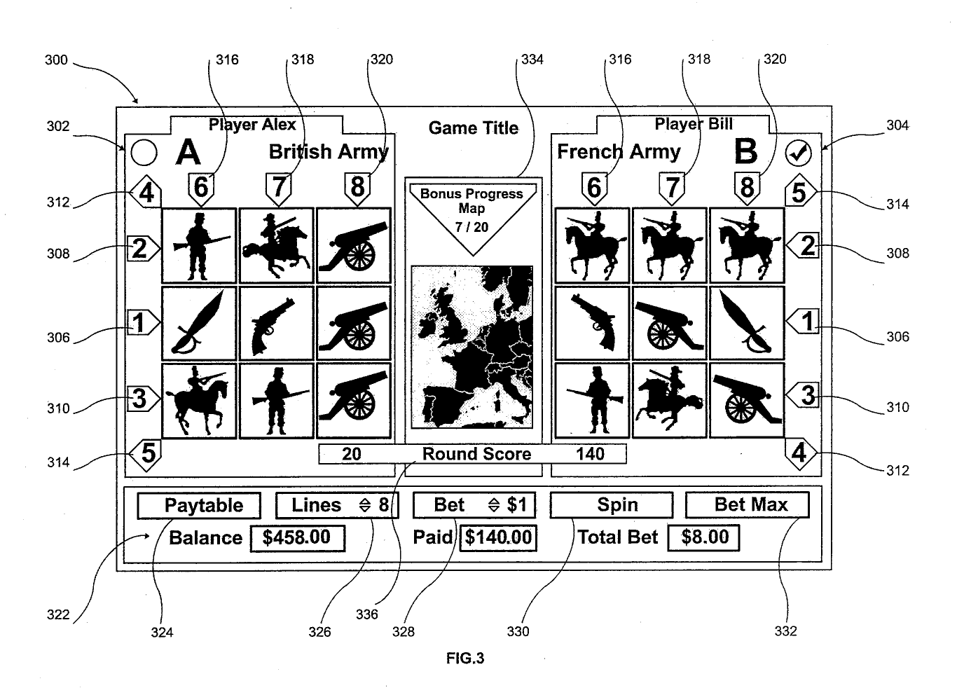

Reference is now made to FIG. 3, in which the layout of a game board 300 in accordance with an embodiment is illustrated. The game board 300 includes a first plurality of cells, such as first group of cells 302 and a second plurality of cells, such as second group of cells 304 where the first group of cells 302 is associated with a first player and the second group of cells 304 is associated with a second player. Where the game is being played in peer-to-computer mode, the live player will be referred to as the first player and the computer (or the “House”) will be referred to as the second player. Where the game is being played in peer-to-peer mode, both the first and second player are live players.

The cells in the first and second groups 302 and 304 may be arranged in an N×M matrix where N represents the number of rows in the matrix and M represents the number of columns in the matrix. N and M may be any whole number greater than one and may be the same or different. In the embodiment shown in FIG. 3, N and M are equal to three, forming 3×3 matrices.

The first and second groups of cells 302 and 304 are configured to form a number of lines, herein after referred to as betting lines. For example, the first and second groups of cells 302 and 304 shown in FIG. 3 are configured so that eight betting lines 306, 308, 310, 312, 314, 316, 318, and 320 are formed, each having three cells. The betting lines may be vertical lines, horizontal lines, or diagonal lines, as shown in FIG. 3, or any other free geometry lines (e.g. broken lines).

During game play, each cell is preferably populated by a symbol, which may be randomly generated by video slot machine 20 or by server 10. In one embodiment, the game has a board game theme and the symbols used to populate the cells are associated with a particular board game. Suitable board games include, but are not limited to, Risk™ Dungeons and Dragons™, Clue™ and Transformers™. In the embodiment shown in FIG. 3, the game has a Risk™ theme. Accordingly, the symbols may comprise various war symbols, such as canons, swords, guns, infantry soldiers, and cavalry soldiers.

In one embodiment, the symbols displayed in the first and second groups of cells 302 and 304 are arranged to face the centre of the game board 300 such that the symbols in the two group of cells can be said to be facing each other. For example, as shown in FIG. 3, the cannon symbols in the first group of cells 302 are pointing toward the right and the cannon symbols in the second group of cells 304 are pointing toward the left. Arranging the symbols in this manner creates the entertaining impression, that the two groups of symbols are opposing armies fighting each other.

It is the configuration of the symbols in the first and second groups of cells 302 and 304 that are used to determine the outcome of a primary game. In one embodiment the first player is provided a first award if the symbols in the first group of cells 302 comprise at least one winning combination. Where the game is played in peer-to-peer mode, the second player is similarly provided a second award if the symbols in the second group of cells 304 comprise at least one winning combination. Preferably, a winning combination occurs when all of the cells in a particular betting line are populated with the identical symbol. In the example, shown in FIG. 3, betting line 308 for Player Bill and betting line 320 for Player Alex have winning combinations. Specifically, betting line 308 for Player Bill is made up of three horsemen and betting line 320 for Player Alex is made up of three cannons.

The first and second player awards may be displayed in an award section 336 of the game board 300. For example, it is shown in FIG. 3 that the first player, Alex, was provided the first award of $20 based on the first winning combination in the betting line 320 and the second player, Bill, was provided the second award of $140 based on second winning combination in the betting line 308. Awards for the first and second winning combinations comprised of various symbols may be awarded in accordance with a payout table. Payout tables are well known in the art and will not be further described.

The game board 300 may further include a player interface 322 that allows a live player to interact with the game. For example, the input interface 322 may include a paytable button 324, a betting lines selector 326, a wager selector 328, a spin button 330, and a bet max button 332. The method for the player to activate the input interface 322 buttons and selectors will depend on the configuration of the client 14 or slot machine 20. For example, where the display 10 of the slot machine 20 or the display of the client 14 is touch screen enabled then the player may simply touch the buttons and selectors to activate them. Alternatively, the player may be provided with a pointing device, such as a mouse or the like, that allows them to “click” on the button or selection.

The paytable button 324, when activated, displays the payout table to the player. The pay table may list, for example, payout odds for winning combinations comprised of various symbols. This is a particularly beneficial feature for a new player who is unfamiliar with the game and the symbols used in the game.

The betting lines selector 326, and the wager selector 328 allow the player to adjust his/her wager for a particular round of the primary game. In one embodiment, the betting lines selector 326 allows the player to select the number of betting lines they wish to bet on. For example, if the player selects two betting lines then the first and second betting lines 306 and 308 are used to determine whether the player receives a payout. This means that if a winning combination occurs in one of the other six betting lines 310, 312, 314, 316, 318, and 320 the player does not receive a payout.

The wager selector 328 allows the player to select the wager amount per betting line. For example, if the wager is $1 and eight betting lines are selected then the total wager is $8.

In another embodiment, the betting lines selector 326 and the wager selector 328 may allow the player to strategically select a different wager for each betting line selected. For example, if the betting line selector 326 is set to betting line 1 then the wager selector 328 can be used to set the wager for betting line 1.

Both the betting lines selector 326 and the wager selector 328 may have a default setting. For example, the betting lines selector 326 may have a default setting equal to the maximum number of betting lines (e.g. eight) and the wager selector 328 may have a default setting equal to the minimum bet (e.g. $1). In the peer-to-computer embodiment, the wager may be automatically set to a particular amount. Alternatively, the second player (i.e. computer or House) wager is automatically matched to the first player's wager.

The spin button 330 and the bet max button 332 are used to activate play of the primary game. The spin button 330 activates the primary game using the settings of the betting lines selector 326 and the wager selector 328. The bet max button 332 activates the primary game using the maximum betting lines and the maximum wager amount. Accordingly, the bet max button 332 effectively ignores the status of the betting lines selector 326 and the wager selector 328.

The player interface 322 may also be used to display other player-specific information such as the player's balance, the total amount paid out to the player and the amount of the current bet. Those skilled in the art will understand that there are many other elements that may be included in the player interface 322.

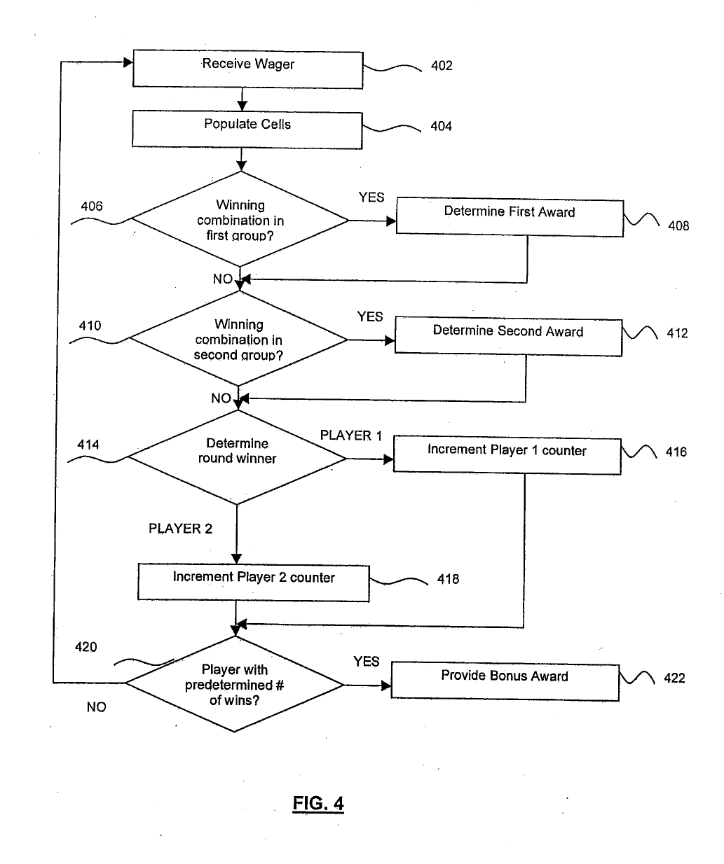

The game board 300 may further include a bonus game section 334 to display the status of a bonus game. Typically the bonus game is designed to encourage the player to play multiple rounds of the primary game. For example, the bonus game may track the number of rounds of the primary game won and award a bonus to player if he/she wins a predetermined number of rounds. A method for determining the winner of a particular round will be described below in relation to FIG. 4.

The bonus game section 334 may display items such as the current number of rounds won for each player and a visual image of the current position of the players with respect to each other.

Where the game of chance has a board game theme, then the bonus game may relate to a plot of the board game. For example, where the game of chance has a Risk™ theme, the bonus game may simulate war between two armies. In particular, say the first player is associated with the British Army and the second player is associated with the French Army, then the bonus game may simulate a war between these two countries so that when the first player wins a round of the primary game the British Army advances its position (e.g. gains control of additional territory) and when the second player wins a round of the primary game the French Army advances its position. In one embodiment, the greater the margin of victory in a round, the greater the territorial advance of the associated Army.

The method according to an embodiment of the present invention will now be described with reference to FIGS. 3 and 4. The method 400 begins at step 402 where a first wager is input by the first player into the video slot machine 20 or by client 14, as the case may be. In the client-server embodiment, the first wager is communicated to the server 10.

Preferably, the first wager amount is fixed and cannot be changed by the first player (e.g. fixed at $1). Preferably, all betting lines are automatically selected and also cannot be changed by the first player. A second wager and betting line selection is made by the second player in preferably the same manner as for the first player (i.e. automatically). In this embodiment, the betting line selector button 326, wager selector button 328, and bet max button 332 shown in FIG. 3 would not be necessary.

In an alternative embodiment applicable to the peer-to-computer mode, the first player (i.e. live player) may be given the option of selecting the amount of the wager and the betting lines to be played using the betting line selector button 326, wager selector button 328, and bet max button 332. In such an embodiment, the second wager amount and pay lines of second player (i.e. House) would automatically be selected to match the first wager and betting line selection of the first player.

In another alternative embodiment applicable to the peer-to-peer mode, each player may be given the option to select the amount of his/her wager (up to a maximum bet) and select one or more betting lines. Each player would select his/her wager and betting line selection in turn using the betting line selector button 326, wager selector button 328, and bet max button 332. Such an embodiment may add an additional strategy and risk element to the game.

At step 404, the first player (in the peer-to-computer mode) or either of the players (in the peer-to-peer mode) press the spin button 330. Each cell in the first and second groups of cells 302, 304 is then populated with a symbol. As described above in relation to FIG. 3, the symbols may be randomly generated by video slot machine 20 or by server 10. In addition, to increase the user's enjoyment of the game, the symbols may relate to a particular board game (e.g. Risk™).

At decision diamond 406, the video slot machine 20 or server 10 determines whether any combinations of the symbols in the first group of cells 302 constitute winning combinations. Where the wager is associated with a specified number of betting lines, only the betting lines associated with the wager can qualify as winning combinations. For example, where the first and second group of cells 302 and 304 are configured for eight betting lines as shown in FIG. 3, and the player only associated the wager with one betting line, then only the selected betting line is used to determine if there is a winning combination. Similarly, where the wager is only associated with two betting lines, only the two selected betting lines are used to determine if there is a winning combination. If no winning combinations are present in the first group of cells 302, the method proceeds to decision diamond 410.

If at least one winning combination is present in the first group of cells, the method proceeds to step 408 where the first award for first player is determined based on the payout odds which depend on the probability of various winning combinations arising, as is known in the art. The first award may be displayed on the display 40 of the slot machine 20 or the display of the client device(s) 14. For example, the first award may be displayed in the award section 336 of the board game 300. The first award may be a monetary award or any other type of award, such as additional credits to play the game. Preferably, the first award is provided to the first player at this step, but may also be awarded at a later stage. The method then proceeds to decision diamond 410.

At decision diamond 410 the video slot machine 20 or server 10 determines whether any combinations of the symbols in the second group of cells 304 constitute winning combinations. Winning combinations are determined in the same manner as described with respect to decision diamond 406.

At step 412, the second award is determined and displayed in the same manner as described with respect to step 408. After the second award is determined, the method proceeds to decision diamond 414. In the peer-to-peer mode, the second award is preferably awarded to the second player at this step, but may be awarded at a later stage. In the peer-to-computer mode, the second award is determined only for the purpose of identifying the round winner, as discussed below.

At decision diamond 414, a round winner is selected by comparing the first award to the second award, with the player having the highest award being selected as the round winner. If the value of the first and second awards is equal, neither player is selected as the round winner. In one embodiment, a bonus award may be awarded to the player who is the round winner. In the peer-to-computer mode, if the second player (i.e. House) is the round winner, this simply means that the first player does not receive the bonus award.

In some embodiments this is the end of the game.

In other embodiments, this only constitutes one round of the game and the method proceeds to either step 416 or 418. If the first player is the round winner, then the method proceeds to step 416 where a counter that keeps track of how many rounds the first player has won is incremented. The method then proceeds to decision diamond 420. If there is a tie, neither counter is incremented and the method returns to step 402 from decision diamond 414.

In the peer-to-peer mode, if the second player is the round winner, then the method proceeds to step 418 where a counter that keeps track of how many rounds the second player has won is incremented. The method then proceeds to decision diamond 420. In the peer-to-computer mode where the second player is the House, a counter for the second player is not required.

In the peer-to-peer mode, at decision diamond 420, the video slot machine 20 or server 10 determines whether either of the players has won a predetermined number of rounds. The predetermined number of rounds may be based on the level of the game. For example, the higher the level of the game, the higher number of games must be won. If none of the players have won the predetermined number of rounds then the method proceeds back to step 402. In the peer-to-computer mode, a check is made only to determine whether the first player has won the predetermined number of rounds. The second player (i.e. House) wins are ignored. Consequently, the first player is preferably always able to win a bonus award provided he/she plays enough rounds. This provides the added advantage of motivating the player to play more rounds.

In the peer-to-peer embodiment, if one of the players has won the predetermined number of rounds, then a bonus award is preferably awarded to the winning player in step 422. In the peer-to-computer embodiment, if the first player has won the predetermined number of rounds then the first player is awarded a bonus award. The bonus award may be a monetary award or any other type of award such as additional credits to play the game.

In one embodiment, the bonus award is based on the total amount wagered in all rounds played. For example, if the first player plays two rounds before they are awarded the bonus, and they wagered $10 in the first round and $5 in the second round, then the amount of the bonus will be based on the total wager in both rounds (i.e. $15).

If the first player exits the game before either of the players has won the predetermined number of rounds, the player's number of rounds won may be saved by the client 14, server 10 or the slot machine 20 for subsequent retrieval. This encourages the player to return at a later time to play this particular game since they do not forfeit credit for any of the winning rounds that they have accumulated.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto.

1. A method of conducting a video game of chance comprising:
a) receiving a first wager from a first player and a second wager from a second player;
b) populating a first plurality of cells with a first plurality of symbols, wherein the first plurality of cells is associated with the first player;
c) populating a second plurality of cells with a second plurality of symbols, wherein the second plurality of cells is associated with the second player;
d) determining whether the first plurality of symbols comprise at least one first winning combination;
e) if the first plurality of cells comprises the at least one first winning combination, determining a first award for the at least one first winning combination;
f) determining whether the second plurality of symbols comprises at least one second winning combination;
g) if the second plurality of cells comprises the at least one second winning combination, determining a second award for the at least one second winning combination; and
h) selecting a round winner based on a comparison of the first and second award, wherein the first player is selected as the round winner if the first award exceeds the second award, wherein the second player is selected as the round winner if the second award exceeds the first award.

2. The method of claim 1, further comprising awarding the first award to the first player.

3. The method of claim 2, further comprising awarding the second award to the second player.

4. The method of claim 1, further comprising.
i) repeating steps (a)-(h) for a plurality of subsequent rounds; and
j) if the first player has won a predetermined number of rounds, determining a first bonus award for the first player.

5. The method of claim 3, further comprising determining a second bonus award for the second player if the second player has won a predetermined number of rounds.

6. The method of claim 1, further comprising updating a bonus game display based on the round winner.

7. The method of claim 6, wherein the bonus game display is situated between the first plurality of cells and the second plurality of cells.

8. The method of claim 7, wherein the bonus game display is associated with a board game plot.

9. The method of claim 1, further comprising:
i) if the round winner is the first player, incrementing a first counter;
j) if the round winner is the second player, incrementing a second counter;
k) determining whether one of the first counter and the second counter is equal to a predetermined value
l) repeating steps a) to k) until one of the first counter and the second counter is equal to or greater than the predetermined value; and
m) if the first counter is equal to or greater than the predetermined value, determining a first bonus award for the first player.

10. The method of claim 1, wherein both the first plurality of cells and the second plurality of cells are arranged in a matrix, each matrix forming a plurality of betting lines.

11. The method of claim 10, wherein each matrix is a N×M matrix, wherein N is a whole number greater than one and M is a whole number greater than one.

12. The method of claim 11, wherein N and M are each equal to three and wherein each matrix forms eight betting lines.

13. The method of claim 12, wherein three identical symbols in one betting line constitutes a first winning combination and a second winning combination.

14. The method of claim 10 further comprising receiving a selection of at least one betting line from the first player, wherein the first winning combination is found in the at least one betting line.

15. The method of claim 1, wherein the second player is a House.

16. The method of claim 1, wherein the first plurality of symbols face the second plurality of symbols and the second plurality of symbols face the first plurality of symbols.

17. The method of claim 1, wherein the first and second plurality of symbols are associated with a board game.

18. A method of playing a video game of chance comprising:
a) communicating a first wager from a first player and a second wager from a second player;
b) displaying a first plurality of cells populated with a first plurality of symbols, wherein the second plurality of cells is associated with the second player;
c) displaying a second plurality of cells populated with a second plurality of symbols, wherein the first plurality of cells is associated with the first player;
d) if the first plurality of symbols comprises at least one first winning combination, displaying a first award to the first player, wherein the first award is determined from the at least one first winning combination;
e) if the second plurality of symbols comprises at least one second winning combination, displaying the second award to the second player, wherein the second award is determined from the at least one second combination; and
f) displaying a round winner based on a comparison of the first and second award, wherein the first player is selected as the round winner if the first award exceeds the second award, wherein the second player is selected as the round winner if the second award exceeds the first award.

19. The method of claim 18, further comprising providing the first award to the first player.

20. The method of claim 19, further comprising:
g) repeating steps (a)-(f) for a plurality of subsequent rounds; and
h) displaying a first bonus award to the first player if the first player is the round winner for a predetermined number of rounds.

21. The method of claim 19, further comprising, displaying a second bonus award to the second player if the second player is the round winner for a predetermined number of rounds.

22. The method of claim 19, further comprising updating a bonus game display based on the round winner.

23. The method of claim 22, wherein the bonus game display is situated between the first plurality of cells and the second plurality of cells.

24. The method of claim 23, wherein the bonus game display is associated with a board game plot.

25. The method of claim 18, further comprising:
g) displaying a first counter, wherein the first counter is incremented when the first player is the round winner;
h) displaying a second counter, wherein the second counter is incremented when the second player is the round winner;
i) repeating steps a) to h) until one of the first counter and the second counter is equal to the predetermined value; and
j) if the first counter is equal to a predetermined value, displaying a first bonus award to the first player.

26. The method of claim 25, further comprising providing the second award to the second player.

27. The method of claim 18, wherein both the first plurality of cells and the second plurality of cells are arranged in a matrix, each matrix forming a plurality of betting lines.

28. The method of claim 27, wherein each matrix is a N×M matrix, wherein N is a whole number greater than one and M is a whole number greater than one.

29. The method of claim 28, wherein N and M are each equal to three and wherein each matrix forms eight betting lines.

30. The method of claim 29, wherein the first winning combination comprises three identical symbols in one betting line.

31. The method of claim 27, wherein
the first wager is further associated with at least one betting line; and
the first winning combination is found in the at least one betting line.

32. The method of claim 18, wherein one of the first and second players is a House.

33. The method of claim 18, wherein the first plurality of symbols face the second plurality of symbols and the second plurality of symbols face the first plurality of symbols.

34. The method of claim 18, wherein the first and second plurality of symbols comprise symbols associated with a board game.

35. A system for conducting a video game of chance between a first player and a second player, the system comprising:
a) a server; and
b) a client device adapted for communication with the server, the client device comprising a display;
wherein the client device is adapted to receive a first wager and communicate the first wager to the server;
wherein the display is adapted to display a first plurality of cells populated with a first plurality of symbols and a second plurality of cells populated with a second plurality of symbols, wherein the first wager is associated with a first plurality of cells, and the second plurality of cells is associated with a second wager;
wherein the server is adapted to:
determine whether the first plurality of symbols comprise at least one first winning combination, and if the first plurality of symbols comprise at least one first winning combination, determine a first award for the at least one first winning combination; and
determine whether the second plurality of symbols comprise at least one second winning combination, and if the second plurality of symbols comprise at least one second winning combination, determine a second award for the at least one second winning combination;
wherein the server is adapted to select a round winner based on a comparison of the first and second award, wherein the first player is selected as the round winner if the first award exceeds the second award, wherein the second player is selected as the round winner if the second award exceeds the first award.

36. A gaming machine for conducting a video game of chance between a first player and a second player, the machine comprising:
a) a processor;
b) a memory;
c) an input interface; and
d) a display
wherein the input interface is adapted to receive a first wager and store the first wager in the memory;
wherein the display is adapted to display a first plurality of cells populated with a first plurality of symbols and a second plurality of cells populated with a second plurality of symbols, wherein the first wager is associated with a first plurality of cells, and the second plurality of cells is associated with a second wager;
wherein the processor is adapted to:
determine whether the first plurality of symbols comprise at least one first winning combination, and if the first plurality of symbols comprise at least one first winning combination, determine a first award for the at least one first winning combination; and
determine whether the second plurality of symbols comprise at least one second winning combination, and if the second plurality of symbols comprise at least one second winning combination, determine a second award for the at least one second winning combination;
wherein the processor is adapted to select a round winner based on a comparison of the first and second award, wherein the first player is selected as the round winner if the first award exceeds the second award, wherein the second player is selected as the round winner if the second award exceeds the first award.
